(19) United States
(12) Patent Application Publication
(10) Pub. No.: US 2026/0117876 A1
(43) Pub. Date: Apr. 30, 2026

(54) AUTOMATED OR MANULALLY OPERATED VALVE WITH VALVE SEAT ENERGIZING ELEMENT

(71) Applicant: RAW Frac Services, LLC, Conroe, TX (US)

(72) Inventors: Jack Allen, Porter, TX (US); James Kiser, Plantersville, TX (US)

(21) Appl. No.: 19/367,217

(22) Filed: Oct. 23, 2025

Related U.S. Application Data
(60) Provisional application No. 63/711,226, filed on Oct. 24, 2024.

(51) Int. Cl. F16K 3/02

(52) U.S. Cl. CPC F16K 3/0227; F16K 25/00

(57) ABSTRACT

The present disclosure may comprise a valve used to control fluid flow. The valve may have an inlet and an outlet connected by a bore through which fluid may flow. A gate may be moveably configured within an internal cavity positioned along a length of the bore. The gate may move between an open position that allows fluid to flow through the gate, and a closed position that does not allow fluid to flow through the gate. Two elastomeric energizing assemblies may be configured on either side of the gate. Lantern rings with lantern ring openings may be configured concentrically with the elastomeric energizing assemblies. Valve seats may be configured between the elastomeric energizing assemblies and the gate. When fluid flows past the lantern ring openings, pressure may increase in the elastomeric energizing assemblies, causing the valve seats to compress against the gate and form a seal with the gate.

### CROSS-REFERENCE TO RELATED APPLICATIONS

The present application is a conversion of U.S. Provisional Application having U.S. Serial No. 63/711,226, filed on October 24, 2024, which claims the benefit under 35 U.S.C. 119(e). The disclosures of which are hereby expressly incorporated herein by reference.

### BACKGROUND OF THE DISCLOSURE

The process of fracking in the oil and gas industry accelerates the migration of petroleum fluid and or natural gas from reservoir rocks. Fracking is a process where frac manifolds consisting of high performance engines and high pressure pumps force a mixture of sand, water and/or chemicals through high pressure flow lines that are attached to devices known in the industry as a frac valve or frac stack. A frac stack is an assembly of multiple frac valves and other frac equipment configured in various sizes and pressure ratings. Frac valves are attached to a wellhead containing high-pressure pipes that extend into gas or oil formations that are many thousands of feet below ground and the pipes are cemented in place. These frac valves are attached to the wellhead by bolting which is tightened to a predetermined torque value by hydraulic tools or manual hammer type tools.

The fracking process incorporates high pressure pumps to inject the fracking media which consists of materials such as fluids, grains of sand, ceramic or other particulates that remain in the cracks formed during the fracking operation preventing the fractures created in the rock formations from closing when the injection pressure is stopped allowing the oil or natural gas to flow through the cracks in the formation into the well bore. The fracking process injects the fracking media through the frac valves for several hours or days. During the fracking process the frac valves are opened and closed multiple times resulting in the possibility of frac media entering the valve body cavity and/or the loss of grease from the valve body cavity.

### SUMMARY OF THE DISCLOSURE

Embodiments of the present disclsoure comprise a valve with an inlet, an outlet, and a bore connecting the inlet and the outlet. The bore may be a hollow cylinder formed within a valve body. Fluid may be configured to flow from the inlet to the outlet through the bore. The fluid configured to flow through the bore may be a fracking fluid. The fluid may comprise water and at least one proppant. The at least one proppant may be sand. The fluid may exit the outlet of the valve and may be used to cause fractures in rock formations such that oil and/or natural gas may escape the rock formations.

An internal cavity of the valve may be configured along a length of the bore between the inlet and the outlet. The internal cavity may be configured halfway between the inlet and the outlet. Alternatively, the internal cavity may be configured closer to the outlet or closer to the inlet. The internal cavity may be at least partially defined by retainer plates that extend outward from the bore. A gate may be moveably configured within the internal cavity. The gate may be configured between the retainer plates such that at least one retainer plate is configured adjacent to a side of the gate closer to the inlet, and such that at least one retainer plate is configured adjacent to a side of the gate closer to the outlet.

The gate may have a gate opening through which the fluid may flow when the gate opening is at least partially aligned with the bore. When the gate opening is at least partially aligned with the bore, the gate is configured in an open position. The gate may also be configured in a closed position such that the gate opening is not aligned with the bore, such that fluid flowing through the bore contacts the gate and is halted by the gate. The gate may be translated laterally through the internal cavity to change between the open position and the closed position. The gate may be translated laterally in a direction perpendicular to the flow of fluid through the bore.

Two elastomeric energizing assemblies may be configured within the internal cavity on opposite sides of the gate such that one of the two elastomeric energizing assemblies (the “upstream elastomeric energizing assembly”) is configured closer to the inlet, and wherein the other of the two elastomeric energizing assembly (the “downstream elastomeric energizing assembly”) is configured closer to the outlet. Each of the two elastomeric energizing assemblies may comprise an elastomeric energizing element. The elastomeric energizing element of each of the two elastomeric energizing assemblies may be configured concentrically around an internal non-extrusion ring. The elastomeric energizing element of each of the two elastomeric energizing assemblies may also be configured concentrically around two inner non-extrusion rings. The two inner non-extrusion rings of each of the elastomeric energizing assemblies may be configured on opposite sides of the corresponding internal non-extrusion ring. Each of the two inner non-extrusion rings may be concentrically surrounded by an outer non-extrusion ring. It should be understood and appreciated that one or more of the components that make up the elastomeric energizing assemblies can be constructed of an elastomer. It is not required that all of the components of the elastomeric energizing assemblies are made of an elastomer.

A valve seat may be configured between each of the two elastomeric energizing assemblies and the gate such that the valve comprises two valve seats. A lantern ring may be configured concentrically with each of the two elastomeric energizing assemblies such that the valve comprises two lantern rings. In some embodiments, the lantern rings may be surrounded concentrically by the internal non-extrusion rings of their corresponding elastomeric energizing assemblies. Each lantern ring may comprise lantern ring openings. The lantern ring openings of each lantern ring may be configured equidistant from one another. In some embodiments, the lantern ring openings of each lantern ring may be configured in arrangement along a circumference of their respective lantern ring. This arrangement may be equidistant from either edge of the respective lantern ring.

When fluid flows through the bore and past the lantern ring openings of the lantern rings, pressure within the elastomeric energizing assemblies may increase. This increase in pressure may cause the elastomeric energizing elements to compress the valve seats into the gate, thereby forming a seal between the valve seats and the gate. This seal may prevent the fluid from leaking out of the valve. In embodiments of the valve that comprise retainer plates, the valve seats may also be compressed into the retainer plates when the valve seats are compressed into the gate.

When the gate is configured in an open position, the fluid may flow past the lantern ring openings of both of the two lantern rings. Pressure may increase in both elastomeric energizing assemblies, causing both elastomeric energizing elements to compress both valve seats into the gate. When the gate is configured in a closed position, fluid may flow past the lantern ring openings of only the lantern ring configured concentrically with the upstream elastomeric energizing assembly, increasing the pressure in the upstream elastomeric energizing assembly, and causing the corresponding elastomeric energizing element to compress the corresponding valve seat into the gate. The fluid may also contact the gate. The fluid contacting the gate, along with the valve seat corresponding to the upstream elastomeric energizing assembly being compressed into the gate, may bias the gate towards the downstream elastomeric energizing assembly. This may cause the valve seat corresponding to the downstream elastomeric energizing assembly to compress into the gate to form a seal.

Embodiments of the present disclosure may also comprise a method of controlling the flow of fluid. A valve with an inlet, an outlet, a bore, and an internal cavity may be provided. The valve may be the same valve as described herein. Fluid may be allowed to flow through the bore from the inlet to the outlet. The internal cavity may be at least partially defined by extending retainer plates outward from the bore in a direction perpendicular to the flow of fluid through the bore.

Two elastomeric energizing assemblies may be provided. Each of the two elastomeric energizing assemblies may have an elastomeric energizing element. One of the two elastomeric energizing assemblies may be an upstream elastomeric energizing assembly configured closer to the inlet. The other of the two elastomeric energizing assemblies may be a downstream elastomeric energizing assembly configured closer to the outlet. The two elastomeric energizing assemblies may be configured within the internal cavity.

A gate with a gate opening may be provided. The gate may be moveably configured between the two elastomeric energizing assemblies such that the gate may translate laterally through the internal cavity in a direction perpendicular to the flow of fluid through the bore. The gate may be configured in an open position by at least partially aligning the gate opening with the bore such that fluid may flow from the inlet to the outlet through the bore and through the gate opening. The gate may be configured in a closed position by moving the gate such that the gate opening is not aligned with the bore, such that the flow of fluid through the bore is halted by the gate.

Two valve seats may be provided. Each of the two valve seats may be configured between one of the two elastomeric energizing assemblies and the gate, such that there is an upstream valve seat and a downstream valve seat. Two lantern rings with lantern ring openings may be provided. Each of the two lantern rings may be configured concentrically with one of the two elastomeric energizing assemblies such that there is an upstream lantern ring and a downstream lantern ring.

The pressure within at least one of the two elastomeric energizing assemblies may be increased by allowing the fluid to flow past the lantern ring openings of the corresponding lantern ring. This may cause the valve seat configured between the gate and the at least one of the two elastomeric energizing assemblies to compress into the gate, thereby forming a seal between the valve seat and the gate. When the gate is configured in the open position, the fluid may flow past the lantern ring openings of both lantern rings, causing the elastomeric energizing elements of both of the two elastomeric energizing assemblies to compress their respective valve seats into the gate.

When the gate is configured in the closed position, the fluid may flow past the lantern ring openings of only the upstream lantern ring, causing the elastomeric energizing element of the upstream elastomeric energizing assembly to compress the upstream valve seat into the gate. This may bias the gate towards the downstream valve seat to compress the downstream valve seat into the gate. The flow of fluid from the inlet against the gate may further bias the gate towards the downstream valve seat to compress the downstream valve seat into the gate.

### BRIEF DESCRIPTION OF DRAWINGS

FIG. 1 shows a front cross-section view of a valve according to embodiments of the present disclosure.

FIG. 2 shows a front cross-section view of the valve of FIG. 1 in an open position.

FIG. 3 shows a front cross-section view of the valve of FIG. 1 in a closed position.

FIG. 4 shows a cross-section view an elastomeric energizing assembly, a lantern ring, a seat seal ring, and a valve seat according to embodiments of the present disclosure.

FIG. 5 shows an exploded cross-section view of the elastomeric energizing assembly of FIG. 4.

FIG. 6 shows an exploded view of the elastomeric energizing assembly of FIG. 4.

### DETAILED DESCRIPTION OF THE DISCLOSURE

Reference now should be made to the drawings, in which the same reference numbers are used throughout the different figures to designate the same components.

It will be understood that, although the terms first, second, third, etc. may be used herein to describe various elements, these elements should not be limited by these terms. These terms are only used to distinguish one element from another element. Thus, a first element discussed below could be termed a second element without departing from the teachings of the present disclosure.

The terminology used herein is for the purpose of describing particular embodiments only and is not intended to be limiting. As used herein, the singular forms “a”, “an”, and “the” are intended to include the plural forms as well, unless the context clearly indicates otherwise. It will be further understood that the terms “comprises” and/or “comprising” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

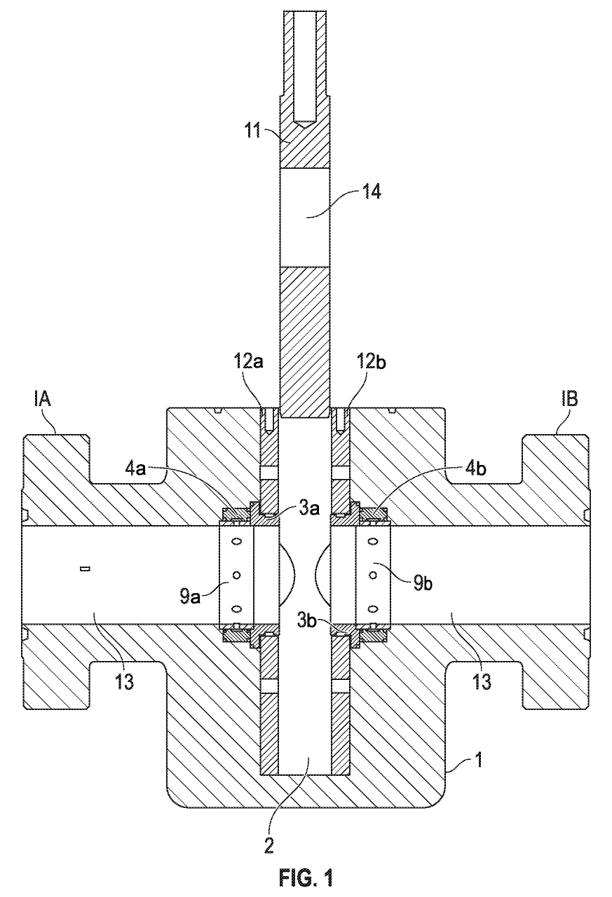

As shown in FIG. 1, a bore 13 extends through a valve body 1 of a valve and connects an inlet 1A to an outlet 1B. An internal cavity 2 is configured along a length of the bore between the inlet 1A and the outlet 1B. The internal cavity 2 extends through the valve body 1 in a direction perpendicular to the bore 13. The internal cavity accepts retainer plates 12 (12a and 12b) that extend outward from the bore 13 along the internal cavity 2 to further define the internal cavity 2. The internal cavity 2 also accepts a gate 11 that is translated through the internal cavity 2 to change between an open position and a closed position. The gate 11 comprises a gate opening 14 that is at least partially aligned with the bore 13 when the gate 11 is configured in an open position, and is not aligned with the bore 13 when the gate 11 is configured in a closed position.

The internal cavity 2 further accepts two elastomeric energizing assemblies 4 (4a and 4b), two lantern rings 9 (9a and 9b), and two valve seats 3 (3a and 3b), all of which are configured concentrically around the bore 13. The elastomeric energizing assembly 4a is configured between the gate 11 and the inlet 1A. The other elastomeric energizing assembly 4b is configured between the gate 11 and the outlet 1B. Each of the two valve seats 3a and 3b are configured between one of the two elastomeric energizing assemblies 4a and 4b and the gate 11. The valve seat 3a is situated such that the valve seat 3a separates the retainer plate 12a from the bore 13 and the valve seat 3b is situated such that the valve seat 3b separates the retainer plate 12b from the bore 13. Each of the two lantern rings 9a and 9b are configured concentrically with the two elastomeric energizing assemblies 4a and 4b, respectively. It should be understood and appreciated that one or more of the components that make up the elastomeric energizing assemblies 4a and 4b can be constructed of an elastomer. It is not required that all of the components of the elastomeric energizing assemblies 4a and 4b are made of an elastomer.

When the gate 11 is not inserted into the internal cavity 2, the elastomeric energizing assemblies 4a and 4b are not energized (i.e., are in a dormant state). When the gate 11 is inserted into the internal cavity 2 by sliding the gate 11 in between the two valve seats 3a and 3b, an interference fit between the gate 11 and the two valve seats 3a and 3b is achieved. This interference fit compresses the elastomeric energizing assemblies 4a and 4b, thereby generating a constant force against the valve seats 3a and 3b to close any gaps, openings, or crevices that would allow media such as fluid to escape the internal cavity 2.

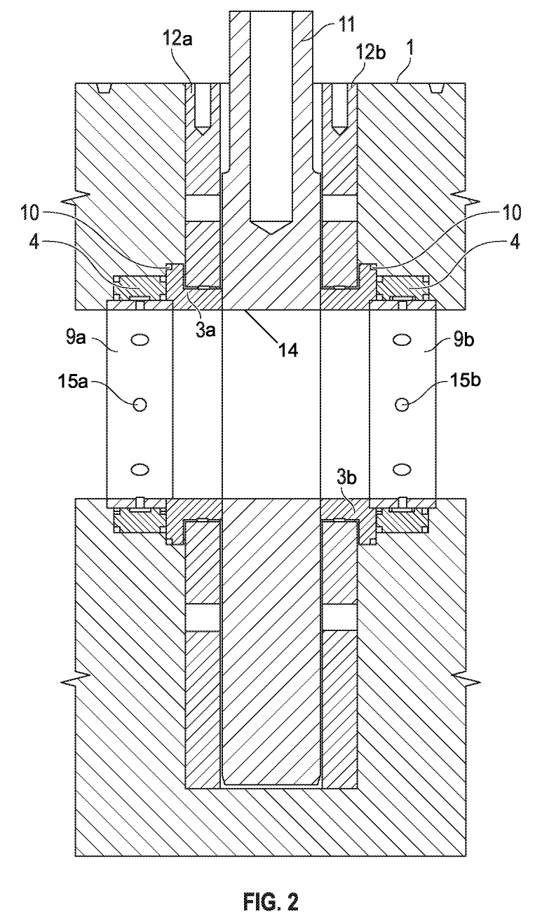

As shown in FIG. 2, the gate 11 is configured in an open position such that fluid can flow through the bore 13 and through the gate opening 14 from the inlet 1A to the outlet 1B. In doing so, the fluid flows past each of the two lantern rings 9a and 9b. Each of the two lantern rings 9a and 9b comprises lantern ring openings 15 (15a and 15b). Fluid flows past the lantern ring openings 15 to increase pressure within the elastomeric energizing assemblies 4a and 4b, thereby compressing the valve seats 3a and 3b into the gate 11 to form a seal between the valve seats 3a and 3b and the gate 11. A seat seal ring 10 is configured on an outer circumferential surface of each valve seat 3a and 3b to form a seal between the valve seats 3a and 3b and the valve body 1.

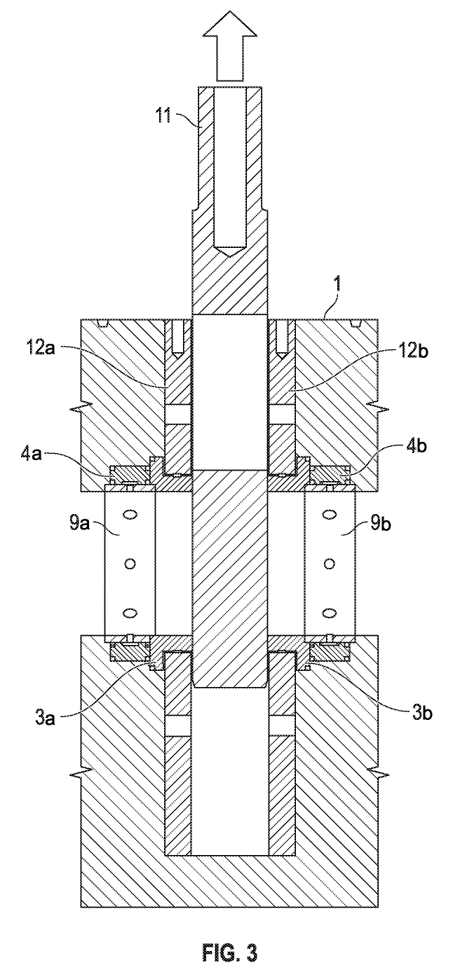

As shown in FIG. 3, the gate 11 is translated laterally through the internal cavity 2 to change from an open position to a closed position such that fluid flowing through the bore 13 cannot pass through the gate 11. In the closed position, fluid flowing through the bore 13 flows past only the lantern ring openings 15a of the lantern ring 9a configured concentrically with the elastomeric energizing assembly 4a configured closer to the inlet 1A (i.e., the “upstream elastomeric energizing assembly”). This increases the pressure within the elastomeric energizing assembly 4a configured closer to the inlet, thereby compressing the valve seat 3a configured between that elastomeric energizing assembly 4a and the gate 11 into the gate 11 to form a seal between the valve seat 3a and the gate 11.

Since pressure is only increased in the upstream elastomeric energizing assembly 4a when the gate 11 is configured in the closed position, the upstream valve seat 3a being compressed into the gate 11 biases the gate 11 towards the valve seat 3b configured between the gate 11 and the elastomeric energizing assembly 4b configured closer to the outlet 1B (i.e., the “downstream elastomeric energizing assembly”), causing the downstream valve seat 3b to compress into the gate 11 as well to form a seal between the downstream valve seat 3b and the gate 11. In addition to the upstream valve seat 3a biasing the gate 11 towards the downstream valve seat 3b, the flow of fluid from the inlet 1A against the gate 11 further causes the gate 11 to be biased towards the downstream valve seat 3b, further compressing the downstream valve seat 3b into the gate 11 to form a seal between the downstream valve seat 3b and the gate 11.

The compressive force between the valve seats 3a and 3b and the gate 11 caused by the interference fit between the valve seats 3a and 3b and the gate 11 and also caused by the increased pressure within the elastomeric energizing assemblies 4a and 4b ensures that constant contact is maintained between the gate 11 and the valve seats 3a and 3b. This constant contact minimizes fluid leaking out of the bore 13 or the internal cavity 2. This constant contact also minimizes lubricating grease in the internal cavity 2 from flowing out of the internal cavity 2 into the bore 13 during opening or closing of the valve (i.e., changing the gate 11 between an open position and a closed position). The minimizing of loss of grease from the internal cavity 2 allows for the valve to be operated without the need to add additional grease over time. The constant contact between the valve seats 3a and 3b and the gate 11 further allows the valve to operate without an external energizing force needed to ensure a tight seal between the valve seats 3a and 3b and the gate 11.

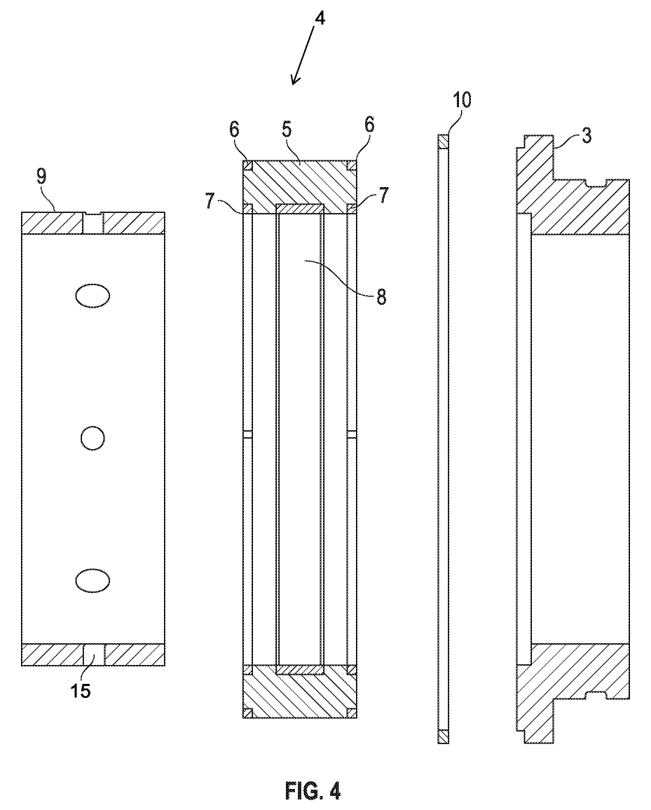

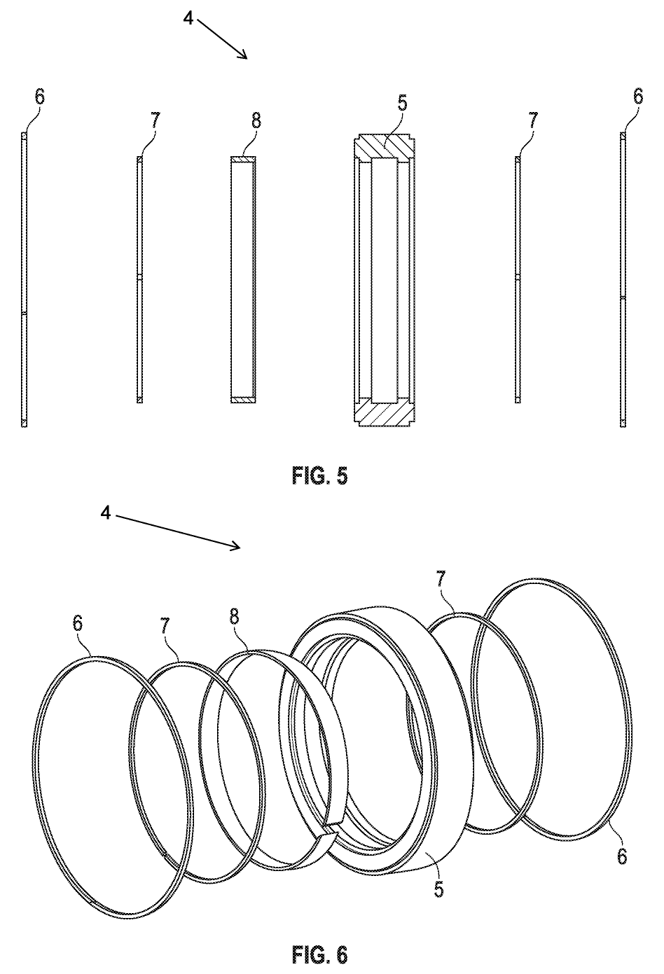

As shown in FIGS. 4-6, each elastomeric energizing assembly 4a and 4b comprises an elastomeric energizing element 5 configured concentrically around an internal non-extrusion ring 8. Two inner non-extrusion rings 7 are configured on either side of the internal non-extrusion ring 8. Two outer non-extrusion rings 6 are also configured on either side of the internal non-extrusion ring 8. Each of the two outer non-extrusion rings 6 is configured concentrically around one of the two inner non-extrusion rings 7.

As shown in FIG. 4, one of the two lantern rings 9 is configured concentrically within the internal non-extrusion rings 8 of its corresponding elastomeric energizing assembly 4. The lantern ring 9 may be configured partially concentrically within its corresponding valve seat 3. The portion of the lantern ring 9 configured concentrically within its corresponding valve seat 3 may be surrounded concentrically by the seat seal ring 10 associated with the valve seat 3. The inner non-extrusion ring 7 and outer non-extrusion ring 6 configured adjacent to the valve seat 3 when the valve is assembled may form seals between the elastomeric energizing assembly and the valve seat 3.

A plurality of additional features and feature refinements are applicable to specific embodiments. These additional features and feature refinements may be used individually or in any combination. It is noted that each of the following features discussed may be, but are not necessary to be, used with any other feature or combination of features of any of the embodiments presented herein.

Unless otherwise defined, all technical and scientific terms used herein have the same meaning as are commonly understood by one of ordinary skill in the art to which this disclosure belongs. Although methods similar or equivalent to those described herein can be used in the practice or testing of the present disclosure, suitable methods are described herein.

All publications, patent applications, patents, and other references mentioned herein are incorporated by reference in their entirety. In case of conflict, the patent specification, including definitions, will prevail. In addition, the materials, methods, and examples are illustrative only and not intended to be limiting.

It will be appreciated by persons skilled in the art that the present disclosure is not limited to what has been particularly shown and described hereinabove. Rather, the scope of the present disclosure is defined by the appended claims and includes both combinations and sub-combinations of the various features described hereinabove as well as variations and modifications thereof, which would occur to persons skilled in the art upon reading the foregoing description.

What is claimed is:

1. A valve comprising:
an inlet;
an outlet;
a bore connecting the inlet and the outlet wherein fluid is configured to flow from the inlet to the outlet through the bore;
an internal cavity extending generally perpendicular to the bore;
a gate moveably configured within the internal cavity, the gate comprising a gate opening,
wherein the gate is configured in an open position whereby the gate opening is at least partially aligned with the bore, whereby fluid flows from the inlet to the outlet through the bore and through the gate opening,
wherein the gate is configured in a closed position whereby the gate opening is not aligned with the bore, whereby the flow of fluid through the bore is halted by the gate;
two energizing assemblies configured within a body of the valve on opposing sides of the gate, each of the two elastomeric energizing assemblies comprising an elastomeric energizing element;
two valve seats, each valve seat being configured between one of the two elastomeric energizing assemblies and the gate; and
two lantern rings, each lantern ring being configured concentrically with one of the two elastomeric energizing assemblies, each of the lantern rings comprising lantern ring openings,
wherein the fluid flowing through the bore past the lantern ring openings increases pressure within the elastomeric energizing assemblies, causing the elastomeric energizing elements to compress the valve seats into the gate thereby forming a seal between the valve seats and the gate to prevent the fluid from leaking out of the valve.

2. The valve of claim 1, wherein the gate is configured in the open position,
wherein fluid flows past the lantern ring openings of both lantern rings;
wherein the elastomeric energizing elements of both of the two elastomeric energizing assemblies compress their respective valve seats into the gate.

3. The valve of claim 1, wherein the gate is configured in the closed position,
wherein fluid flows past the lantern ring openings of only the lantern ring configured concentrically with the elastomeric energizing assembly configured closer to the inlet,
wherein the elastomeric energizing element of the elastomeric energizing assembly configured closest to the inlet compresses its respective valve seat into the gate,
wherein the gate is biased towards the valve seat configured between the gate and the elastomeric energizing assembly configured closer to the outlet, whereby both the valve seats are compressed into the gate.

4. The valve of claim 1, wherein the lantern ring openings of each lantern ring are configured equidistant from one another.

5. The valve of claim 1, wherein the lantern ring openings of each lantern ring are configured in an arrangement along a circumference of their respective lantern ring equidistant from either edge of their respective lantern ring.

6. The valve of claim 1, wherein each of the two elastomeric energizing assemblies further comprise an internal non-extrusion ring surrounded concentrically by the elastomeric energizing element.

7. The valve of claim 6, wherein each of the two elastomeric energizing assemblies further comprise two inner non-extrusion rings surrounded concentrically by the elastomeric energizing element, each of the two inner non-extrusion rings being configured on an opposite side of the internal non-extrusion ring.

8. The valve of claim 7, wherein each of the two elastomeric energizing assemblies further comprise two outer non-extrusion rings, each of the two outer non-extrusion rings being configured concentrically around a respective one of the two inner non-extrusion rings.

9. The valve of claim 6, wherein the lantern ring corresponding with each of the two elastomeric energizing assemblies is surrounded concentrically by the internal non-extrusion ring of its respective elastomeric energizing assembly.

10. The valve of claim 1, further comprising retainer plates that extend outward from the bore and further define the internal cavity.

11. The valve of claim 10, wherein the valve seats are compressed into the gate, the valve seats are also compressed into the retainer plates.

12. The valve of claim 1, wherein the gate is translated laterally through the internal cavity to change between the open position and the closed position.

13. The valve of claim 1, wherein the fluid comprises:
water; and
at least one proppant.

14. The valve of claim 13, wherein the proppant is sand.

15. A method of controlling the flow of fluid comprising:
providing a valve comprising:
an inlet;
an outlet;
a bore connecting the inlet and the outlet whereby the fluid is configured to flow from the inlet to the outlet through the bore;
an internal cavity configured along a length of the bore between the inlet and the outlet;
providing two elastomeric energizing assemblies, each comprising an elastomeric energizing element;
configuring the two elastomeric energizing assemblies within a body of the valve;
providing a gate comprising a gate opening;
moveably configuring the gate within the internal cavity between the two elastomeric energizing assemblies;
configuring the gate in an open position wherein the gate opening is at least partially aligned with the bore, wherein fluid flows from the inlet to the outlet through the bore and through the gate opening;
configuring the gate in a closed position wherein the gate opening is not aligned the bore, wherein the flow of the fluid through the bore is halted by the gate;
providing two valve seats;
configuring each of the two valve seats between one of the elastomeric energizing assemblies and the gate;
providing two lantern rings, each comprising lantern ring openings;
configuring each of the two lantern rings concentrically with one of the two elastomeric energizing assemblies; and
increasing pressure within at least one of the two elastomeric energizing assemblies by allowing the fluid to flow past the lantern ring openings of the corresponding lantern ring,
wherein increasing the pressure within the at least one of the two elastomeric energizing assemblies causes the valve seat configured between the gate and the at least one of the two elastomeric energizing assemblies to compress into the gate, thereby forming a seal between the valve seat and the gate.

16. The method of claim 15, wherein the gate is configured in the open position,
wherein fluid flows past the lantern ring openings of both of the two lantern rings,
wherein the elastomeric energizing elements of both of the two elastomeric energizing assemblies compress their respective valve seats into the gate.

17. The method of claim 15, wherein the gate is configured in the closed position,
wherein fluid flows past the lantern ring openings of only the lantern ring configured concentrically with the elastomeric energizing assembly configured closer to the inlet,
wherein the elastomeric energizing element of the elastomeric energizing assembly configured closest to the inlet compresses its respective valve seat into the gate,
wherein the gate is biased towards the valve seat configured between the gate and the elastomeric energizing assembly configured closer to the outlet, whereby both of the two valve seats are compressed into the gate.

18. The method of claim 15, wherein the gate is translated laterally through the internal cavity to change between the open position and the closed position.

19. The method of claim 15, further comprising at least partially defining the inner cavity by extending retainer plates outward from the bore.

20. The method of claim 15, wherein the fluid comprises:
water; and
at least one proppant.
